(19) United States
(12) Patent Application Publication
(10) Pub. No.: US 2026/0244407 A1
(43) Pub. Date: Aug. 20, 2026

(54) AI EVALUATION OF CHANGES TO COMPUTER-IMPLEMENTED PROCESSES

(71) Applicant: INTERNATIONAL BUSINESS MACHINES CORPORATION, Armonk, NY (US)

(72) Inventors: Neelamadhav Gantayat, Bangalore (IN); Avirup Saha, Kolkata (IN); Renuka Sindhgatta Rajan, Bengaluru (IN); Kushal Mukherjee, New Delhi (IN); Jayachandu Bandlamudi, Guntur (IN); Sachindra Joshi, Gurgaon (IN)

(21) Appl. No.: 19/055,257

(22) Filed: Feb. 17, 2025

(51) Int. Cl. G06F 8/10; G06F 9/54; G06Q 10/0631

(52) U.S. Cl. CPC G06F 8/10; G06F 9/54; G06Q 10/06313

(57) ABSTRACT

A computer hardware system is configured to evaluate a proposed modification to a current computer-implemented process. A plan descriptive of the proposed modification is received from a client computer associated with a user. The plan is decomposed, by a planner agent, into a set of ordered computer-implemented tasks. A set of APIs respectively corresponding to the computer-implemented tasks are identified by Application Programming Interface (API) mapping agent and from descriptions of APIs previously-stored within the computer hardware system. Pseudocode corresponding to the plan is generated by a code translator using the set of APIs and the current computer-implemented process. A change quantum for the plan is determined by a change quantifier agent. The change quantum is compared to an allocated resource measure; and the current computer-implemented process is caused to be modified by the plan based upon the change quantum being less than the allocated resource measure.

### BACKGROUND

The present invention relates to evaluating and implementing changes to computer-implemented processes, and more specifically, employing artificial intelligence (AI) to evaluate proposed changes to the computer-implemented process regarding an allocated resource measure using AI-generated pseudocode.

Different types of changes are possible for a business process. These changes can include a process change (e.g., the addition of conditions, tasks, etc.), an IT application change (i.e., a change of an underlying application that supports the process), and a combination of a process change and IT application change. Examples of a process change is the addition of an approval step or the adding of a conditional branch. An examples of an IT application change would be changing from Notes to Outlook. An example of a combination would be replacing a checkpoint with a new performance management system.

In response to proposed changes, there are currently different types of change impact analysis. For example, the analysis might identify/predict components in a software application that are likely to change. Additionally, while effort estimation exists, this is focused on a single software system (e.g., functional point analysis). Additionally, current analysis typically requires expert identification of the components that are likely to be impacted. Moreover, software component complexity can complicate the impact analysis. Currently, there is a need for a change evaluation system that can assess technical feasibility of changes as well as determine the quantum of software code that needs to be modified to accommodate a proposed change.

### SUMMARY

A method is performed by a computer hardware system including a planner agent, an Application Programming Interface (API) mapping agent, a code translator, and a change quantifier agent for evaluating a proposed modification to a current computer-implemented process. Using the planner agent, a plan descriptive of the proposed modification is received from a client computer associated with a user. The plan is decomposed, by the planner agent, into a set of ordered computer-implemented tasks. A set of APIs respectively corresponding to the computer-implemented tasks are identified by the API mapping agent and from descriptions of APIs previously-stored within the computer hardware system. Pseudocode corresponding to the plan is generated by the code translator using the set of APIs and the current computer-implemented process. A change quantum for the plan is determined by the change quantifier agent. The change quantum is compared to an allocated resource measure; and the current computer-implemented process is caused to be modified by the plan based upon the change quantum being less than the allocated resource measure.

Additionally, the methodology includes the pseudocode can be translated into an orchestration code corresponding to a target environment, in which the orchestration code is used to determine the change quantum, and the target environment is an environment in which the current computer-implemented process operations. The identifying of the set of APIs can include translating a description of each of the computer-implemented tasks into an API specification. Additionally, the computer-implemented tasks can be evaluated against a business policy associated with the current computer-implemented process, and an initial determination regarding a feasibility of the proposed modification can be made based upon the evaluation. Also, feedback based upon the evaluation can be returned to the client computer associated with the user. In certain aspects, at least one of the set of the ordered computer-implemented tasks is determined to not have a corresponding API previously-stored within the computer system; and external sources are searched for an API that corresponds to the at least one of the set of the ordered computer-implemented tasks. Based upon the searching, a determination can be made that a new API is to be developed that corresponds to the at least one of the set of the ordered computer-implemented tasks not having the corresponding API previously-stored within the computer system. In further aspects, the quantifier agent employs a machine learning approach to determine the change quantum, and in other aspects, the quantifier agent employs a rule based approach to determine the change quantum.

A computer hardware system includes a planner agent, an Application Programming Interface (API) mapping agent, a code translator, and a change quantifier agent for evaluating a proposed modification to a current computer-implemented process. The computer hardware system also includes a hardware processor configured to initiate the following operations. Using the planner agent, a plan descriptive of the proposed modification is received from a client computer associated with a user. The plan is decomposed, by the planner agent, into a set of ordered computer-implemented tasks. A set of APIs respectively corresponding to the computer-implemented tasks are identified by the API mapping agent and from descriptions of APIs previously-stored within the computer hardware system. Pseudocode corresponding to the plan is generated by the code translator using the set of APIs and the current computer-implemented process. A change quantum for the plan is determined by the change quantifier agent. The change quantum is compared to an allocated resource measure; and the current computer-implemented process is caused to be modified by the plan based upon the change quantum being less than the allocated resource measure.

Additionally, the system includes the pseudocode can be translated into an orchestration code corresponding to a target environment, in which the orchestration code is used to determine the change quantum, and the target environment is an environment in which the current computer-implemented process operations. The identifying of the set of APIs can include translating a description of each of the computer-implemented tasks into an API specification. Additionally, the computer-implemented tasks can be evaluated against a business policy associated with the current computer-implemented process, and an initial determination regarding a feasibility of the proposed modification can be made based upon the evaluation. Also, feedback based upon the evaluation can be returned to the client computer associated with the user. In certain aspects, at least one of the set of the ordered computer-implemented tasks is determined to not have a corresponding API previously-stored within the computer system; and external sources are searched for an API that corresponds to the at least one of the set of the ordered computer-implemented tasks. Based upon the searching, a determination can be made that a new API is to be developed that corresponds to the at least one of the set of the ordered computer-implemented tasks not having the corresponding API previously-stored within the computer system. In further aspects, the quantifier agent employs a machine learning approach to determine the change quantum, and in other aspects, the quantifier agent employs a rule based approach to determine the change quantum.

A computer program product comprises a computer readable storage medium having stored therein program code for evaluating a proposed modification to a current computer-implemented process. The program code, which when executed by a computer hardware system including a planner agent, an Application Programming Interface (API) mapping agent, a code translator, and a change quantifier agent, causes the computer hardware system to perform the following. Using the planner agent, a plan descriptive of the proposed modification is received from a client computer associated with a user. The plan is decomposed, by the planner agent, into a set of ordered computer-implemented tasks. A set of APIs respectively corresponding to the computer-implemented tasks are identified by the API mapping agent and from descriptions of APIs previously-stored within the computer hardware system. Pseudocode corresponding to the plan is generated by the code translator using the set of APIs and the current computer-implemented process. A change quantum for the plan is determined by the change quantifier agent. The change quantum is compared to an allocated resource measure; and the current computer-implemented process is caused to be modified by the plan based upon the change quantum being less than the allocated resource measure.

Additionally, the compute program product includes the pseudocode can be translated into an orchestration code corresponding to a target environment, in which the orchestration code is used to determine the change quantum, and the target environment is an environment in which the current computer-implemented process operations. The identifying of the set of APIs can include translating a description of each of the computer-implemented tasks into an API specification. Additionally, the computer-implemented tasks can be evaluated against a business policy associated with the current computer-implemented process, and an initial determination regarding a feasibility of the proposed modification can be made based upon the evaluation. Also, feedback based upon the evaluation can be returned to the client computer associated with the user. In certain aspects, at least one of the set of the ordered computer-implemented tasks is determined to not have a corresponding API previously-stored within the computer system; and external sources are searched for an API that corresponds to the at least one of the set of the ordered computer-implemented tasks. Based upon the searching, a determination can be made that a new API is to be developed that corresponds to the at least one of the set of the ordered computer-implemented tasks not having the corresponding API previously-stored within the computer system. In further aspects, the quantifier agent employs a machine learning approach to determine the change quantum, and in other aspects, the quantifier agent employs a rule based approach to determine the change quantum.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a block diagram illustrating an example architecture of a code change evaluation system according to an embodiment of the present invention.

FIG. 2 is a block diagram illustrating a methodology of evaluating a proposed code change using the architecture of FIG. 1 according to an embodiment of the present invention.

FIGS. 3A-3C respectively illustrate an exemplary existing process and how that process could be modified.

FIGS. 4A-4B respectively illustrate pseudocode for an existing process versus proposed pseudo code for a modified process.

FIG. 5 is flow chart illustrating how a natural language description of a plan is acted upon using the methodology of FIG. 2.

FIG. 6 is a block diagram illustrating an example of a computer environment for implementing portions of the methodology of FIG. 2.

### DETAILED DESCRIPTION

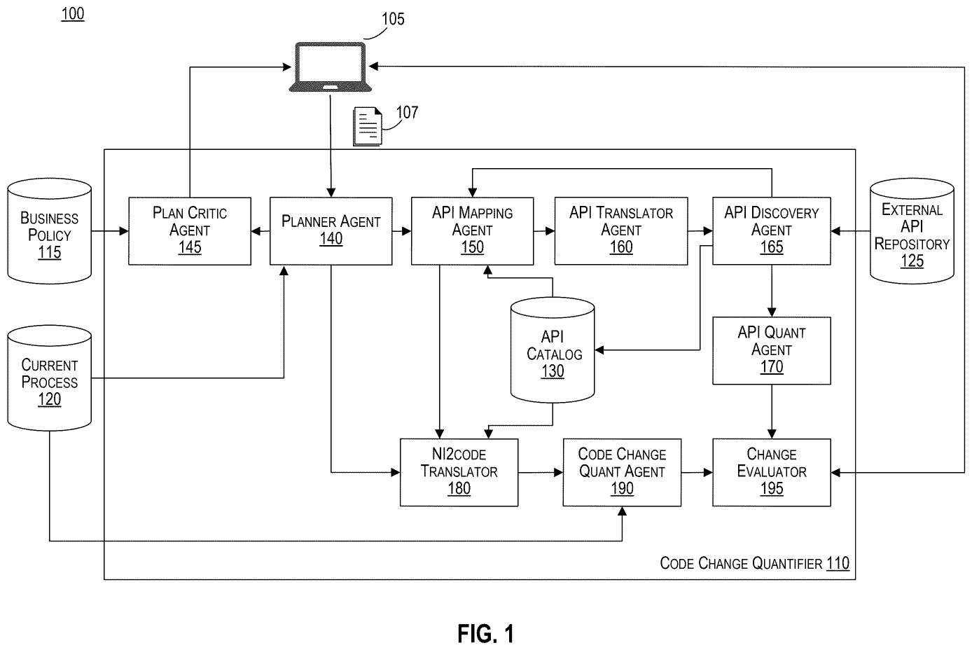

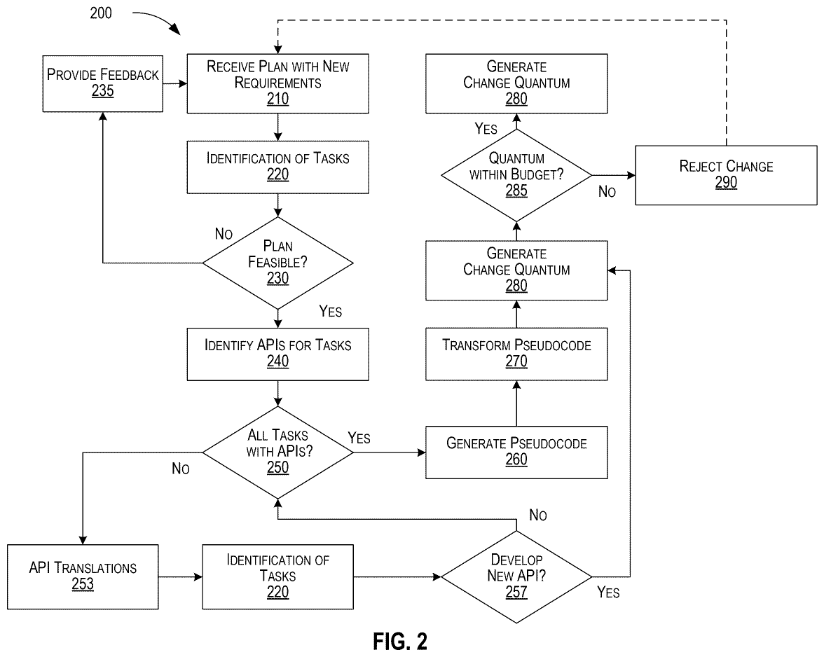

Referring to FIGS. 1 and 2, an exemplary code change evaluation system 100 and methodology 200 of using the same are illustrated. In general, the methodology 200 employs one or more agents 140, 145, 150, 160, 165, 170, 180, 190 within a code change quantifier 110 to evaluate a proposed modification to a current computer-implemented process. A description of the current computer-implemented process can be found within storage 120. Using a planner agent 140, a plan 107 descriptive of the proposed modification is received from a client computer 105 associated with a user. The plan 107 is decomposed, by the planner agent 140, into a set of ordered computer-implemented tasks. A set of APIs respectively corresponding to the computer-implemented tasks are identified by an API mapping agent 150 and from descriptions of APIs previously-stored within the computer hardware system, for example, within an API catalog 130. Pseudocode corresponding to the plan 107 is generated by a code translator 180 using the set of APIs and the current computer-implemented process (e.g., found in storage 120). A change quantum for the plan 107 is determined by a change quantifier agent 190. The change quantum is compared to an allocated resource measure, and the current computer-implemented process (e.g., found in storage 120) is caused to be modified by the plan 107 based upon the change quantum being less than the allocated resource measure.

Although not limited in this manner, the code change quantifier 110 includes a number of components including a planner agent 140, a plant critic agent 145, API mapping agent 150, API translation agent 160, API discovery agent 165, API quantifier agent 170, code translator 180, code change quantifier agent 190 and change evaluator 195. Although these components are illustrated as being separate components, one or more of these components can be integrated together and/or provided as software as a service, as further described with regard to FIG. 6. One or more of the agents 140, 145, 150, 160, 165, 170, 180, 190 can employ some form of artificial intelligence.

With specific reference to FIG. 2, an overview of the general process 200 for employing the code change evaluation system 100 is disclosed. In 210, a plan 107 is received from a client computer 105 associated with a user by the planner agent 140. As used herein, a plan 107 is a description of a modification to an existing computer-implemented process (e.g., found in storage 120). The description can refer to just the modification or a combination of the modification and the current computer-implemented process (e.g., found in storage 120). Although not limited in this manner, the plan 107 can be a natural language description of the activities to be performed. Additionally, the plan 107 should describe the atomic individual tasks, which if executed by different APIs, that will correctly lead to the proper execution of the process embodied by the plan 107. In certain aspects, the plan 107 should not include superfluous steps (tasks) or skip any steps. Additionally, each step (or task) should be described in such a manner as to include all the information necessary to perform the task.

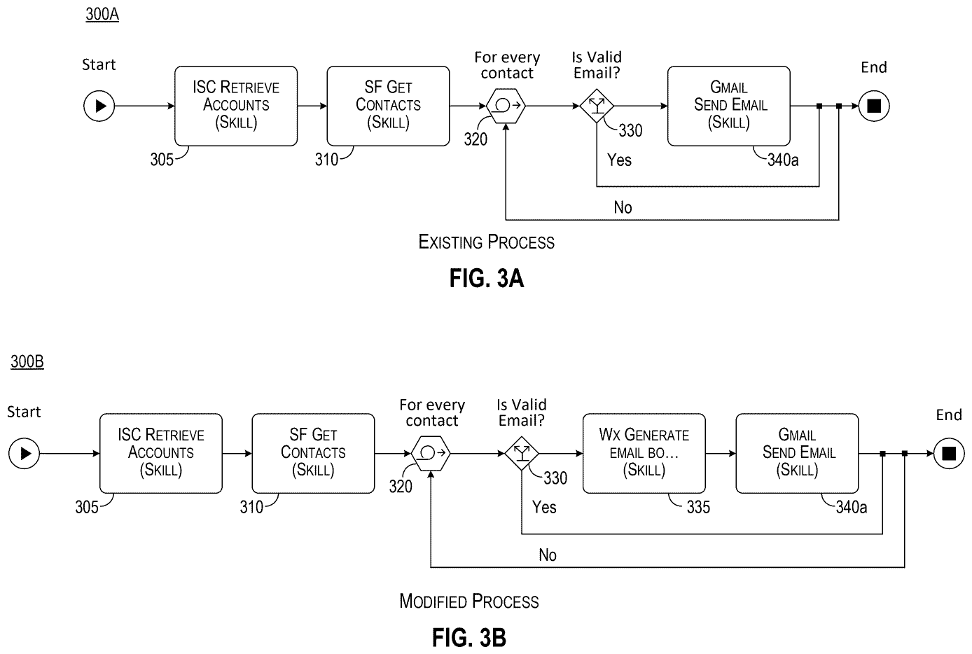

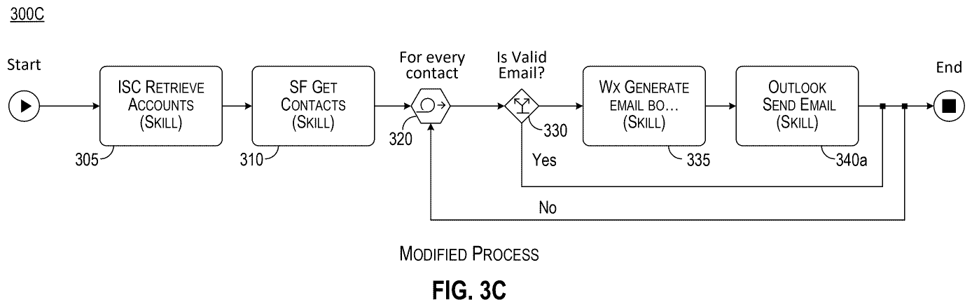

Example approaches to modifying a current process (e.g., found in storage 120) are illustrated with regard to FIGS. 3A-3C. FIG. 3A illustrates an existing process 300A that includes the computer-implemented tasks of retrieving a list of accounts 305, obtaining contact information 310 for each of the accounts, performing a loop operation for each contact 320 of determining whether the email is valid 330 and then sending an email to the contact using a particular program (e.g., Gmail) 340. Referring to FIG. 3B, a modified process 300B can include an operation of automatically generating the email using account information 335. As another example, and with reference to FIG. 3B, a modified process 300C can also include an operation of automatically generating the email using account information 335 as well as using a different program (e.g., Outlook) to send the email 340B.

Also discussed with regard to operation 285, an allocated resource measure (i.e., a measure of resources intended to be allocated to the plan 107) can be provided by the user (e.g., via client computer 105) in addition to the plan 107 itself. The allocated resource measure is not limited as to a particular measure. For example, the allocated resource measure can be a particular monetary value, a percentage of total budget, workforce-hours, or some other measure of resources that will be used to implement the plan 107. This allocated resource measure will be subsequently used to evaluate whether the plan 107 is feasible given this measure.

In 220, the planner agent 140 is configured to decompose the plan 107 into a set of computer-implemented ordered tasks. Although not limited in this manner, the planner agent 140 can be a neural network (e.g., a LLM) that is specifically trained to perform this particular operation. For example, the planner agent 140 can employ natural language processing to identify different tasks with the plan 107.

In 230, separate from determining whether the plan is feasible given the allocated resource measure, an initial automated determination can be performed by plan critic agent 145 as to whether the proposed plan 107 is feasible based upon the identified tasks determined by the planner agent 140 in 220. Plan critic agent 145 can evaluate the tasks using a business policy 115 associated with the current computer-implemented process (e.g., found in storage 120). The association between the business policy 115 and the current computer-implemented process (e.g., found in storage 120) is not limited to a particular association, but in certain aspects, the association is that the business policy 115 is for a particular organization and the current computer-implemented process (e.g., found in storage 120) is being performed by that organization.

Although not limited in this manner, the plan critic agent 145 can be a neural network (e.g., a LLM) that is specifically trained to perform this particular operation. If the plan 107 is evaluated by the plan critic agent 145 as not being feasible, the plan critic agent 145 can be configured to generate feedback, in 235, that can be provided to the user (e.g., via client computer 105). The process 200 can then return back to the user (e.g., via client computer 105) to generate a new plan 107 based upon the feedback.

By way of example, the plan 107 may be to “congratulate students who have scores above 60 using Hotmail,” and this plan 107 can be broken down into the tasks of 1) extract student names from database, 2) create a list of students with score >60, 3) draft email, and 4) send an email to each student using Hotmail. The plan critic agent 145 can automatically evaluate each of the identified tasks against the business policy 115, which can include, for example, a requirement that “an official email address must be used for all communications from organization.” Based upon this particular requirement within the business policy 115, the plan critic agent 145 can generate feedback (e.g., “modify the plan to use official email instead of Hotmail,” “ensure that the official email is used for all communications,” and/or “review the plan again to ensure that the plan is consistent with business policy”) that can be provided back to the user (e.g., via client computer 105).

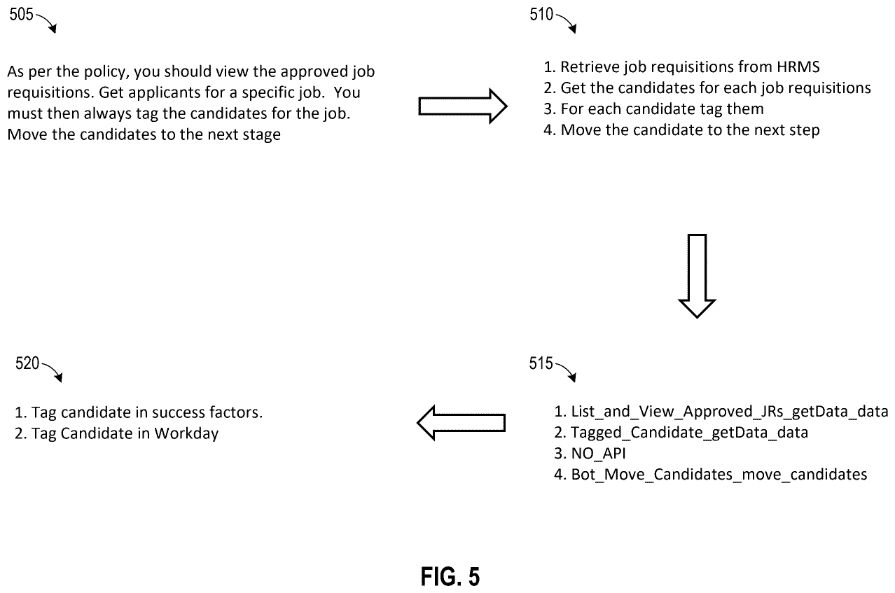

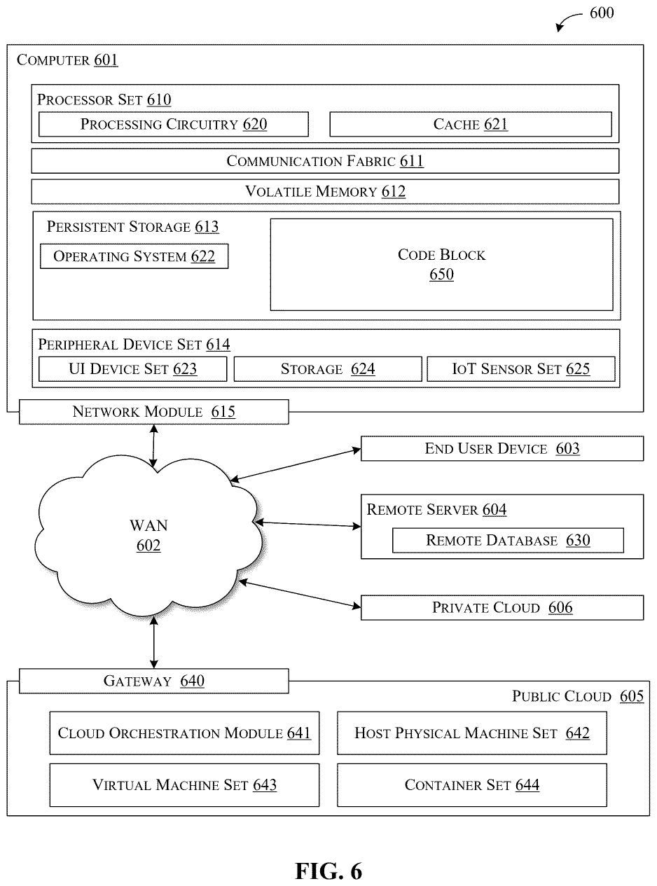

In 240, the API mapping agent 150 identifies APIs from API catalog 130 based upon the tasks 510 identified by the planner agent 140 in 220. Although not limited in this manner, the API mapping agent 150 can be a neural network (e.g., a LLM) that is specifically trained to perform this particular operation. By way of example and referring to FIG. 5, as previously discussed, a natural language description 505 of the plan 107 can be decomposed into a set of ordered tasks 510. Using the set of ordered tasks, the API mapping agent 150 compares a description of the tasks in the ordered tasks 510 to descriptions of APIs within the API catalog 130. The API mapping agent 150 is trained to select, from the API catalog 130, the APIs most suitable to perform the tasks in the ordered tasks 510 to generate a list 515 of APIs. The role of the API mapping agent 150 does not involve the creation of an API when no suitable API can be found within the API catalog. In an instance in which no suitable API is found, the API mapping agent 150 associates a suitable identifier (e.g., “NO_API”) with the task for which no suitable API is found.

In 250, a determination is made whether all the identified tasks 510 have associated therewith APIs in the list 515 of APIs. Although not limited in this manner, this determination can be performed by the API mapping agent 150. If all of the identified tasks 510 do not have associated therein APIs in the list 515 of APIs, the process 200 proceeds to operations 253/255/257 for each task that does not have an associated API. Otherwise, the process 200 proceeds to operation 260.

In 253, an API translator agent 160 translates a description of each task that does not have an associated API into an API specification 520. Although not limited in this manner, the API translator agent 160 can be a neural network (e.g., a LLM) that is specifically trained to perform this particular operation. For example, the API translator agent 160 can include a specially-trained LLM (e.g., IBM's Granite) that can receive, as inputs, an existing requirements document and corresponding real word API specifications as well as a description of the task that does not have an associated API and generate a corresponding API specification 520 as an output. By way of example and referring to FIG. 5, the task of “For each candidate tag them” was evaluated by the API translator agent 160 and the two corresponding API specifications 520 were generated: (i) “Tag candidate in success factors,” and (ii) “Tag Candidate in Workday.”

In 255, the API specifications 520 generated in 253 are fed into an API discovery agent 165. The API discovery agent 165 is configured to search external sources of APIs 125 using the received API specifications 520 to identify suitable API that are capable of satisfactorily perform the task. Although not limited in this manner, the API discovery agent 165 can be a neural network (e.g., a LLM) that is specifically trained to perform this particular operation. If a suitable API is discovered, the API and its associated documentation can be stored within the API catalog 130.

An illustrative example of the operations 210, 220, 240, and 253 are illustrated with regard to FIG. 5. A natural language description 404 of the plan 107 is received in 210. In 220, the natural language description 505 of the plan 107 is decomposed into a number of tasks 510. In 240, APIs are identified for each of the tasks 510. For the task in which an API is not identified (e.g., “For each candidate tag them”), a corresponding API specification 520 is identified.

Returning to FIG. 2., in 257, a determination is made, for each task that does not have an associated API, whether a new suitable API was discovered in 255 or whether there is a need to develop a new API that is suitable for the task. If a determination is made that a new API should be developed, this information is passed to the change evaluator 195, which is subsequently discussed with regard to operation 280. Regardless, the process 200 returns back to operation 250 to evaluate whether all the identified tasks 510 have associated therewith APIs in the list 515 of APIs.

After a determination in 250 that all the identified tasks 510 have associated therewith APIs in the list 515 of APIs (or a determination is made that a new API needs to be developed), the process 200 proceeds to 260, in which pseudocode corresponding to the plan 107 is generated by a translator 180. Although not limited in this manner, the translator 180 can be a neural network (e.g., a LLM) that is specifically trained to perform this particular operation. The translator 180 can include, for example, a nl2code (natural language to code) translator. Many types of nl2code translators are known and the present code change quantifier 110 is not limited to a particular type.

In certain aspects, the translator 180 can be configured to use, as input, data from planner agent 140 (e.g., the identified tasks 500), the API mapping agent 150 (e.g., the identification of APIs), and the API catalog 130 (e.g., API specifications for the particular one in the list 515 of APIs associated with these identified tasks 510). The output of the translator 180 is pseudocode corresponding to the plan 107 along with field mappings, glue code, transformation, and any additional information that could be used to evaluate the pseudocode. The pseudocode (or orchestration code) can be generated in a representational language (e.g., Python). While Python is used in certain aspects of the code change evaluation system 100, other programming languages can be used.

In 270, where necessary, the orchestration pseudocode is transformed to target environment. This operation can be performed by the translator 180 and/or quantifier agent 190. For example, while the orchestration code may be in a generic language (e.g., Python), the target environment may use a different language (e.g., Java). Although not limited in this manner, the translator 180 and/or quantifier agent 190 can be a neural network (e.g., a LLM) that is specifically trained to perform this particular operation.

In 280, a change quantum for the plan 107 is determined using a quantifier agent 190. The quantifier agent 190 is not limited as to a particular approach for determining the change quantum. For example, the quantifier agent 190 can employ a rule based approach, a machine learning approach, or a combination thereof. Regardless of the approach, the quantifier agent 190 is configured to estimate an amount of resources that are expected to be needed to implement the plan 107. This measure can be in number of lines of code, a particular monetary value, workforce-hours, or the like. The measure will be based upon a comparison of the current process code (e.g., found in storage 120) to the orchestration pseudocode generated by the translator 180.

A rule based approach, for example, can vary based upon different scenarios. Additionally, the quantifier agent 190 can also identify and aggregate change quantums for different personas, e.g., a developer persona, software tester persona, and a business-related persona. In the different scenarios discussed below, the average number of hours needed to perform a particular task can be based upon historical data.

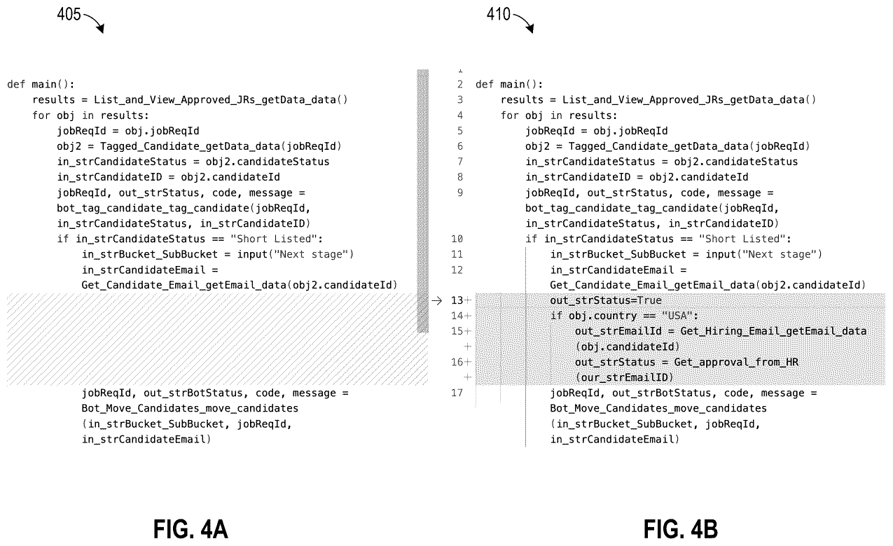

An example of one scenario is a situation in which the original API specification is used and changes are made to the schema. In this scenario, for a developer persona and as an example, the measure can be the number of lines of pseudocode corresponding to the new process operations/IT services. For example, with reference to FIGS. 4A and 4B, the original pseudocode 405 is illustrated in FIG. 4A, and the new pseudocode 410, based upon the new requirements is illustrated in FIG. 4B. The quantifier agent 190 can be configured to compare the new pseudocode 410 to the old pseudocode 405 and identify any changes. In the example illustrated in FIGS. 4A and 4B, the new pseudocode includes 6 additional lines, which can constitute the change quantum for that particular change. Alternatively, the change quantum can be the number of additional lines multiplied by a standard factor (e.g., the average number of hours required to generate a line of pseudocode).

In this same scenario, for a software tester persona and as an example, the measure can be the number of existing test cases that need modifications corresponding to the new process operations/IT services multiplied by a standard factor (e.g., the average number of hours required to modify a test case). Additionally, for a business persona and as an example, the measure can be the number of business activities that need modifications (e.g., updating documentation or activity inputs) multiplied by a standard factor (e.g., the average number of hours required to update a business process activity). This assumes that a mapping exists between the business process activity and an associated API specification.

An example of another scenario in which a new API specification is created. In this different scenario, for a developer persona, the measure can be determined to be the number of endpoints in the new API specification multiplied by some standard factor (e.g., average number of hours required to expose a new API endpoint) in addition to the number of lines of pseudocode corresponding to the new process operations/IT services multiplied by some standard factor (e.g., the average number of hours required to generate a line of pseudocode).

In this same different scenario, for a software tester persona and as an example, the measure can be the number of test cases required for the new API endpoints multiplied by a standard factor (e.g., the average number of hours required to create an API endpoint test case). Additionally, for a business persona and as an example, the measure can be the number of business activities that need modifications (e.g., updating documentation or activity inputs) multiplied by a standard factor (e.g., the average number of hours required to update a business process activity). This assumes that a mapping exists between the business process activity and an associated API specification.

Like the rule based approach, a machine learning approach can vary based upon different scenarios. Additionally, the quantifier agent 190 can also identify and aggregate change quantums for different personas, e.g., a developer persona, software tester persona, and a business-related persona. In the different scenarios discussed below, the average number of hours needed to perform a particular task can be based estimated using a machine learning model. The model for estimating the average number of hours can be trained on previous code assist datasets that capture the addition lines of code a developer writes on top of AI-generated code.

An example of one scenario is a situation in which the original API specification is used and changes are made to the schema. In this scenario, for a developer persona and as an example, the measure can be the number of lines of pseudocode corresponding to the new process operations/IT services. Alternatively, the change quantum can be the number of additional lines multiplied by a standard factor (e.g., the average number of hours required to generate a line of pseudocode).

An example of another scenario in which a new API specification is created. In this different scenario, for a developer persona, the measure can be determined to be the number of endpoints in the new API specification multiplied by some standard factor (e.g., average number of hours required to expose a new API endpoint) in addition to the number of lines of pseudocode corresponding to the new process operations/IT services multiplied by some standard factor (e.g., the average number of hours required to generate a line of pseudocode).

In 285, the change quantum identified in 280 is compared to an allocated resource measure. The manner by which the allocated resource measure is determined is not limited as to a particular approach. The measure can be automatically calculated based upon certain factors or it can be provided by the user (e.g., via client computer 105)—for example, the allocated resource measure can accompany the plan 107 that was received in 210. If the change quantum has a value that is at or below the allocated resource measure, the plan 107 is accepted, and the code change evaluation system 100 can cause the changed to be implemented in 295. Otherwise, if the change quantum is greater than the allocated resource measure, the plan 107 is rejected in 290. The rejection of the plan 107 can include sending feedback to the user (e.g., via client computer 105), which can result in the user submitting a modified plan 107 in 210.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

Referring to FIG. 6, computing environment 600 contains an example of an environment for the execution of at least some of the computer code involved in performing the inventive methods, such as code block 650 for implementing the operations of the code change evaluation system 100. Computing environment 600 includes, for example, computer 601, wide area network (WAN) 602, end user device (EUD) 603, remote server 604, public cloud 605, and private cloud 606. In certain aspects, computer 601 includes processor set 610 (including processing circuitry 620 and cache 621), communication fabric 611, volatile memory 612, persistent storage 613 (including operating system 622 and method code block 650), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. However, to simplify this presentation of computing environment 600, detailed discussion is focused on a single computer, specifically computer 601. Computer 601 may or may not be located in a cloud, even though it is not shown in a cloud in FIG. 6 except to any extent as may be affirmatively indicated.

Processor set 610 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In certain computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in code block 650 in persistent storage 613.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible, hardware device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 611 is the signal conduction paths that allow the various components of computer 601 to communicate with each other. Typically, this communication fabric 611 is made of switches and electrically conductive paths, such as the switches and electrically conductive paths that make up busses, bridges, physical input/output ports and the like. Other types of signal communication paths may be used for the communication fabric 611, such as fiber optic communication paths and/or wireless communication paths.

Volatile memory 612 is any type of volatile memory now known or to be developed in the future. Examples include dynamic type random access memory (RAM) or static type RAM. Typically, the volatile memory 612 is characterized by random access, but this is not required unless affirmatively indicated. In computer 601, the volatile memory 612 is located in a single package and is internal to computer 601. In addition to alternatively, the volatile memory 612 may be distributed over multiple packages and/or located externally with respect to computer 601.

Persistent storage 613 is any form of non-volatile storage for computers that is now known or to be developed in the future. The non-volatility of the persistent storage 613 means that the stored data is maintained regardless of whether power is being supplied to computer 601 and/or directly to persistent storage 613. Persistent storage 613 may be a read only memory (ROM), but typically at least a portion of the persistent storage 613 allows writing of data, deletion of data and re-writing of data. Some familiar forms of persistent storage 613 include magnetic disks and solid state storage devices. Operating system 622 may take several forms, such as various known proprietary operating systems or open source Portable Operating System Interface type operating systems that employ a kernel. The code included in code block 650 typically includes at least some of the computer code involved in performing the inventive methods.

Peripheral device set 614 includes the set of peripheral devices for computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some aspects, storage 624 may take the form of a quantum computing storage device for storing data in the form of qubits. In aspects where computer 601 is required to have a large amount of storage (for example, where computer 601 locally stores and manages a large database) then this storage 624 may be provided by peripheral storage devices designed for storing very large amounts of data, such as a storage area network (SAN) that is shared by multiple, geographically distributed computers. Internet-of-Things (IoT) sensor set 625 is made up of sensors that can be used in IoT applications. For example, one sensor may be a thermometer and another sensor may be a motion detector.

Network module 615 is the collection of computer software, hardware, and firmware that allows computer 601 to communicate with other computers through a Wide Area Network (WAN) 602. Network module 615 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 615 are performed on the same physical hardware device. In other aspects (for example, aspects that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any Wide Area Network (for example, the internet) capable of communicating computer data over non-local distances by any technology for communicating computer data, now known or to be developed in the future. In some aspects, the WAN 602 ay be replaced and/or supplemented by local area networks (LANs) designed to communicate data between devices located in a local area, such as a Wi-Fi network. The WAN 602 and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In certain aspects, EUD 603 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604. As defined herein, the term “server” means a data processing system configured to share services with one or more other data processing systems.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other aspects, a private cloud 606 may be disconnected from the internet entirely (e.g., WAN 602) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 605 and private cloud 606 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A computer-implemented method by a computer hardware system including a planner agent, an Application Programming Interface (API) mapping agent, a code translator, and a change quantifier agent for evaluating a proposed modification to a current computer-implemented process, comprising:
receiving, by the planner agent and from a client computer associated with a user, a plan descriptive of the proposed modification;
decomposing, by the planner agent, the plan into a set of ordered computer-implemented tasks;
identifying, by the API mapping agent and from descriptions of APIs previously-stored within the computer hardware system, a set of APIs respectively corresponding to the computer-implemented tasks;
generating, by the code translator and using the set of APIs and the current computer-implemented process, pseudocode corresponding to the plan;
determining, by the change quantifier agent, a change quantum for the plan;
comparing the change quantum to an allocated resource measure; and
causing the current computer-implemented process to be modified by the plan based upon the change quantum being less than the allocated resource measure.

2. The method of claim 1, further comprising:
translating the pseudocode into an orchestration code corresponding to a target environment, wherein
the orchestration code is used to determine the change quantum, and
the target environment is an environment in which the current computer-implemented process operations.

3. The method of claim 1, wherein
the identifying includes translating a description of each of the computer-implemented tasks into an API specification.

4. The method of claim 1, further comprising:
evaluating the computer-implemented tasks against a business policy associated with the current computer-implemented process; and
making an initial determination regarding a feasibility of the proposed modification based upon the evaluation, wherein
feedback based upon the evaluation is returned to the client computer associated with the user.

5. The method of claim 1, further comprising:
determining that at least one of the set of the ordered computer-implemented tasks does not have a corresponding API previously-stored within the computer system; and
searching external sources for an API that corresponds to the at least one of the set of the ordered computer-implemented tasks.

6. The method of claim 5, further comprising:
determining, based upon the searching, that a new API is to be developed that corresponds to the at least one of the set of the ordered computer-implemented tasks not having the corresponding API previously-stored within the computer system.

7. The method of claim 1, wherein
the quantifier agent employs a machine learning approach to determine the change quantum.

8. The method of claim 1, wherein
the quantifier agent employs a rule based approach to determine the change quantum.

9. A computer hardware system including a planner agent, an Application Programming Interface (API) mapping agent, a code translator, and a change quantifier agent for evaluating a proposed modification to a current computer-implemented process, comprising:
a hardware processor configured to initiate the following executable operations:
receiving, by the planner agent and from a client computer associated with a user, a plan descriptive of the proposed modification;
decomposing, by the planner agent, the plan into a set of ordered computer-implemented tasks;
identifying, by the API mapping agent and from descriptions of APIs previously-stored within the computer hardware system, a set of APIs respectively corresponding to the computer-implemented tasks;
generating, by the code translator and using the set of APIs and the current computer-implemented process, pseudocode corresponding to the plan;
determining, by the change quantifier agent, a change quantum for the plan;
comparing the change quantum to an allocated resource measure; and
causing the current computer-implemented process to be modified by the plan based upon the change quantum being less than the allocated resource measure.

10. The system of claim 9, wherein the hardware processor is further configured to initiate the following executable operation:
translating the pseudocode into an orchestration code corresponding to a target environment, wherein
the orchestration code is used to determine the change quantum, and
the target environment is an environment in which the current computer-implemented process operations.

11. The system of claim 9, wherein
the identifying includes translating a description of each of the computer-implemented tasks into an API specification.

12. The system of claim 9, wherein the hardware processor is further configured to initiate the following executable operations:
evaluating the computer-implemented tasks against a business policy associated with the current computer-implemented process; and
making an initial determination regarding a feasibility of the proposed modification based upon the evaluation, wherein
feedback based upon the evaluation is returned to the client computer associated with the user.

13. The system of claim 9, wherein the hardware processor is further configured to initiate the following executable operations:
determining that at least one of the set of the ordered computer-implemented tasks does not have a corresponding API previously-stored within the computer system; and
searching external sources for an API that corresponds to the at least one of the set of the ordered computer-implemented tasks.

14. The system of claim 13, wherein the hardware processor is further configured to initiate the following executable operation:
determining, based upon the searching, that a new API is to be developed that corresponds to the at least one of the set of the ordered computer-implemented tasks not having the corresponding API previously-stored within the computer system.

15. The system of claim 9, wherein
the quantifier agent employs a machine learning approach to determine the change quantum.

16. The system of claim 9, wherein
the quantifier agent employs a rule based approach to determine the change quantum.

17. A computer program product, comprising:
a computer readable storage medium having stored therein program code,
the program code, which when executed by a computer hardware system including a planner agent, an Application Programming Interface (API) mapping agent, a code translator, and a change quantifier agent for evaluating a proposed modification to a current computer-implemented process, causes the computer hardware system to perform:
receiving, by the planner agent and from a client computer associated with a user, a plan descriptive of the proposed modification;
decomposing, by the planner agent, the plan into a set of ordered computer-implemented tasks;
identifying, by the API mapping agent and from descriptions of APIs previously-stored within the computer hardware system, a set of APIs respectively corresponding to the computer-implemented tasks;
generating, by the code translator and using the set of APIs and the current computer-implemented process, pseudocode corresponding to the plan;
determining, by the change quantifier agent, a change quantum for the plan;
comparing the change quantum to an allocated resource measure; and
causing the current computer-implemented process to be modified by the plan based upon the change quantum being less than the allocated resource measure.

18. The computer program product of claim 13, wherein the computer hardware system is further caused to perform:
translating the pseudocode into an orchestration code corresponding to a target environment, wherein
the orchestration code is used to determine the change quantum, and
the target environment is an environment in which the current computer-implemented process operations.

19. The computer program product of claim 13, wherein the computer hardware system is further caused to perform:
evaluating the computer-implemented tasks against a business policy associated with the current computer-implemented process; and
making an initial determination regarding a feasibility of the proposed modification based upon the evaluation, wherein
feedback based upon the evaluation is returned to the client computer associated with the user.

20. The computer program product of claim 13, wherein the computer hardware system is further caused to perform:
determining that at least one of the set of the ordered computer-implemented tasks does not have a corresponding API previously-stored within the computer system;
searching external sources for an API that corresponds to the at least one of the set of the ordered computer-implemented tasks; and
determining, based upon the searching, that a new API is to be developed that corresponds to the at least one of the set of the ordered computer-implemented tasks not having the corresponding API previously-stored within the computer system.
